(19) United States
(12) Patent Application Publication
(10) Pub. No.: US 2005/0240506 A1
(43) Pub. Date: Oct. 27, 2005

(54) Method or process for selling shares of stock by a private corporation at different arrangements to a plurality of accredited investors over the internet

(76) Inventor: Larry Melvin Koenig, Marina Del Rey, CA (US)

Correspondence Address: Larry M. Koenig, #312, 13970 Panay Way, Marina Del Rey, CA, 90292, US

(21) Appl. No.: 10/831,855

(22) Filed: Apr. 26, 2004

(51) Int. Cl. G06F 17/60

(52) U.S. Cl. 705/37

(57) ABSTRACT

A method for selling shares of stock by a private corporation at different arrangements through a capital raising auction to a plurality of accredited investors. Auction is conducted through an on-line network of computers operating independently but linked to the central computer. Bidders are registered as accredited investors. Corporation inputs business plan and request for auction to a moderator who determines feasibility from an analysis score by investors. Corporation data is finalized with shares available and price per share. Investor inputs bid or re bid on shares, price per share, bid requirements, added value and response time. Corporation and the investor negotiate until criteria acceptance or non response. Closing date or no shares available, whichever comes first, concludes auction regardless of any negotiation stage. Stock sale is finalized through escrow where winners or corporation can cancel. Winners can auction their shares in a similar manner for an early exit strategy.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of business management of an enterprise and more specifically to a method or process for selling shares of stock by a private corporation at different arrangements to a plurality of accredited investors over the Internet.

Obtaining capital for start up or early stage businesses has been extremely difficult in the past. Money raised in more than 90% of the cases came from personal funds, bank loans, SBA or credit card loans, and friends and family. This type of money was very limited in the amount that could be raised and often produce severe hardships on the business operation. Obtaining larger sums through the equity marketplace from private accredited investor, angel investors or venture capital has been near impossible for the average company due to their requirements and the company's inability to locate the right type of equity investors. Negotiations are usually one to one with the equity investor defining the rules due to the limited competition. Our invention add a new and cost-effective method for raising equity capital for corporations.

Prior technology that permitted a corporation to submit a business plan on-line in a modified version were only presented to a limited number of investors for viewing and deciding if they were interested in investing. The business plan was not rated nor was there any attempt to improve upon the plan's quality after submission. There was no competitve bidding and the number of and the amount of any investment was very small in comparision to the number of plans submitted. A corporation was generally at the mercy of the investors, as they usually decided as a group if an investment would be made. There was no variation on how the shares were priced, as investors usually conferred with each other. This method prevented many qualified corporations from receiving any type of capital for growth if the majority of the group voted against. Bidding on shares in a private corporation was not a method used in the past. Once an investment was made, the only two exit strategies for investors were waiting until the corporation grew to a size that it could be acquired or becoming public by an IPO or other means. This usually took many years and in most cases never occurred. Investors were never able to exit out of the investment except by a negotiated settlement with the corporation. U.S. Pat. No. 5,794,219 allows a pooling of bids that can be used to achieve the purpose of buying shares for all. U.S. Pat. No. 6,161,099 allows an auctioneer to moderate an auction that is limited only to a bid price on a specific quantity of shares and where the bid must conform to the rules of the auction. U.S. Pat. No. 6,499,018 provides for a bid limitation closing date problems, which is not an issue here. U.S. Pat. No. 6,629,082 provide a technique for an auction system that is used for pricing and allocating registered equity securities in a public marketplace. Information about an offering to accept bids for equity shares is provided to qualified potential purchasers and non-qualified potential purchasers. Private corporations are addressed here. U.S. Pat. No. 6,289,318 provides a point system for referral rewards and a method of reward distribution only. It does not referral to the internet and matching of name.

Prior methods did not use an auction or bidding system for selling multiples shares at different configurations by a bid and response system where price was not the only issue. Past methods did not provide competition between investors as they knew each other and collusion usually resulted. Rating of a private corporation's business plan on multiple categories was not done except on an overall basis. A business plan that was rated poorly was not able to be resubmitted, as investors were not interested at this stage. An early exit strategy for investors through a supplemental auction where any portion of the acquired shares could be auctioned to other accredited investors was never done, unless shares were registered in the public marketplace. A corporation that purchased a business or marketing plan on-line had to purchase the complete item rather than individual building block modules that could either be fitted within the original plan or used as the ground work for a new plan.

### BRIEF SUMMARY OF THE INVENTION

The primary object of the invention is to provide a method for raising capital for a private corporation from a plurality of accredited investors by a bid and response on-line auction where individual bids are hidden from other investors.

Another object of the invention is to provide a method so a corporation can accept multiple winning bids from different accredited investors for shares of stock based on a combination of price per share, bid requirements and added value instead of price alone.

Another object of the invention is to provide a method for rating individual investments prior to an auction by investors.

A further object of the invention is to provide a method that requires an answer within a timeframe after each bid and response that ensures eventual closure between parties prior to an auction closing.

Yet another object of the invention is to provide a method of acknowledgement between a bidder and responder that ensures a completed deal for shares so they can be subtracted from available shares.

Still yet another object of the invention is to provide a method for an automatic after auction escrow that allows a bidder and responder to either perform due diligence for final acceptance or cancellation within an allocated period of time.

Another object of the invention is to provide a method for a pre auction rating system of a private corporation's business plan by plurality of accredited investors on multiple categories that ensures auction feasibility.

Another object of the invention is to provide a method so an investor can preset specific investment criteria based on an industry selected that triggers notification of the auction to said investor.

A further object of the invention is to provide a method so the investor can preset specific sell criteria for shares won on a prior auction.

Yet another object of the invention is to provide a method for an early exit strategy for the winning bidder through a supplemental auction where any portion of the acquired shares can be auctioned to other accredited investors.

Still yet another object of the invention is to provide a method for the corporation to purchase building block modules that can either be fitted within the prior created structure or plans or used as a base for a new structure or plan.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a method or process for selling shares of stock by a private corporation at different arrangements to a plurality of accredited investors over the Internet comprising the steps of: an on-line network of computers operating independently but linked to the central computer that comprise a method for raising capital by bidding on available shares based on different arrangements, inputting registration to the central computer by a customer and a plurality of accredited investors for bidding on an on-line auction controlled by an opening and a closing date and available shares, inputting a numerical score where investors can rate a business plan based on multiple categories and 1 to 10 scale for each category that when added together produces a total that converts to a criteria analysis, inputting a business plan to the central computer by the customer wanting to raise capital for a corporation that can be modified for an auction after reviewing the criteria analysis by the investors, inputting request for the auction by the corporation that can be accepted or rejected by a moderator based on shares, price per share, valuation and criteria analysis by the investors, outputting to the investor a notification of auction that matches the investor's criteria for bidding, inputting bid or re bid to an open auction through the central computer by the investor based on personal interest or bidding criteria, inputting the response to a bid or the response to a re bid from either the investor or the corporation on an open auction via the central computer until a mutual acceptance or the response date expires, inputting all auction winners to escrow by the corporation when either the closing date is reached or all shares are sold, whichever comes first, inputting an escrow period for the final auction winners and the corporation so they can perform due diligence for accepting or canceling the sale, and inputting a new auction for an auction winner wanting to sell the winning shares to other investors at any future time.

In accordance with a preferred embodiment of the invention, there is disclosed a method or process for creating and selling semi custom building block modules with real time updating that can be used within a specific structure or plan for use by a customer to generate revenue for a business comprising the steps of: an on-line computer where the customer can input data relating to the type and purpose of the structure or plan, an entry forms related to the particular module with criteria for data entry for the specific structure or plan, an interactive form and update display where the customer and a seller can work in real time if needed to complete the project, a price list comprising various types of building block modules, and calculating a price for each module chosen that gives the customer a right to purchase said modules through a credit card transaction in accordance with the terms of the purchase.

In accordance with a preferred embodiment of the invention, there is disclosed a method or process for obtaining participants by a referral from either a third party or a participant party wherein these parties can be rewarded on a separate basis if a new participant registers and generate revenue through any program within the system comprising the steps of: an on-line computer where a third party can register if not already registered on a fee basis and a participant party can register if not already registered as a participant, a separate section where the third party or participant party can input data relating to the referred party, personalized message and method of contact, a system where the referred party is match against all other tables that contain people by last name and phone number or last name and email address, wherein a match is reject and a non match is accepted, an update and delete section where the third party or participant party can modify or delete referred party, wherein if last name, phone number or email are change then a match is instituted as before for acceptance or rejection, a check box on all registration sections of a participant party or a third party requesting if the registering party was referred, a section in the registration portion of the program that matches the registering party against a table of referred parties, a field in the registration table that links the registered party to the third party or participant party, a calculated output response to the third party or participant party occurs if the participant party performs a service or purchases a product or service that results in revenue generated through any program within the system, a separate program that calculates the value of the purchase or performance based on certain criteria and records that amount in a record linked to the third party or participant party, and said program performs an accounting where additional rewards can be entered and payment of rewards can be recorded on a separate basis that depends on how the parties initially registered.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart of the corporate and inventor's auction process that comprise the method in 18 steps in claim 1.

FIG. 2 is a relational database diagram of the tables within program for the corporate portion of the auction related to FIG. 1.

FIG. 3 is a relational database diagram of the tables within program for the investor's portion of the auction related to FIG. 1.

FIG. 4 is a flow chart of the operations that comprise the method in claim 9.

FIG. 5 is a flow chart of the operations that comprise the method claim 11.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

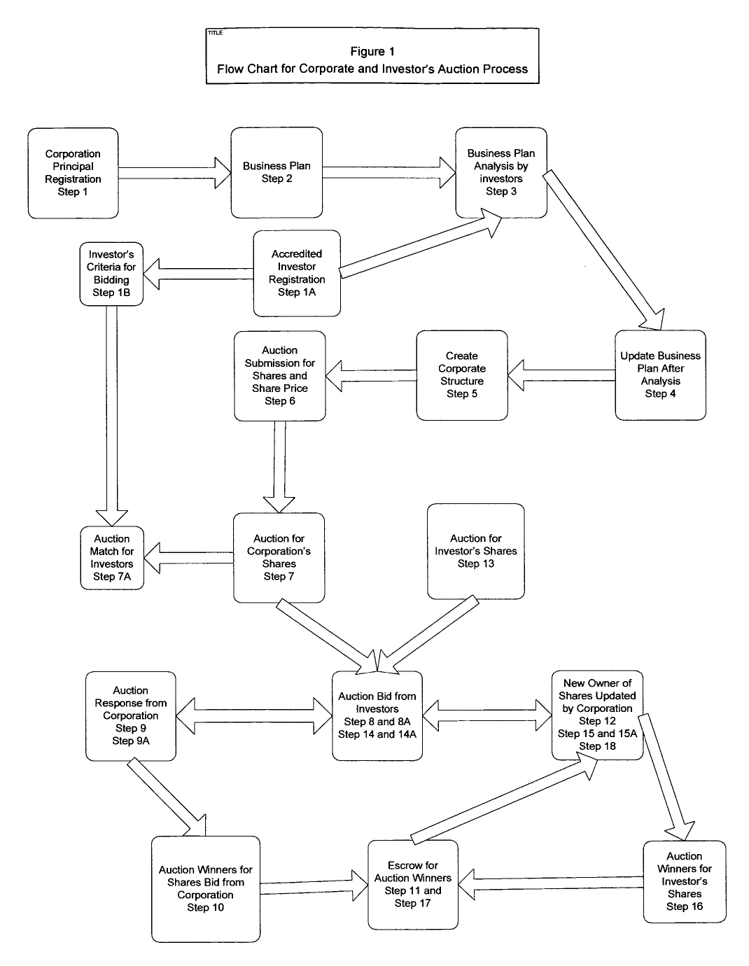

Turning first to FIG. 1 there is shown the method or process for selling shares of stock by a private corporation at different arrangements to accredited investors over the Internet through an on-line network of computers operating independently but linked to the central computer that comprising the steps of 1 through 18 described in claim A1 for raising capital:

Steps 1 and 1A are required for inputting registration to the central computer by a corporation and a plurality of investors that must be accredited for the on-line auction.

Step 1B allows the investors to input their matching criteria for bidding.

Step 2 requires the inputting of business plan criteria to the central computer by the corporation wanting to raise capital.

Step 3 request pre auction analysis by the investors of the business plan that include corporate valuation through a numerical score based on multiple categories and 1 to 10 scale for each category that when added together produces a total that converts to a criteria analysis. This is important as most business plans have problems.

Step 4 allows the corporation to correct these flaws prior proceeding further.

Step 5 requires that the corporate structure be completed by the customer.

Step 6 set up the auction submission process for shares allocated for auction and the share price based on valuation determine by the corporation but influenced by investor analysis. Request for auction by the corporation that can be accepted or rejected by a moderator based on shares, price per share, valuation and criteria analysis by the investors at this point if the share price is not realistic.

Step 7 is where the actual auction is set up by a moderator comprising of an opening and closing date, shares allocated for auction and the price of each share as set by the corporation.

Step 7A provides for the computer to calculate which investors should be contacted based on their input of matching criteria for bidding.

Step 8 and 8A shows how investors input bids or re bids for shares, price per share, bid requirements, added value and response time.

Step 9 and 9A show how the corporation respond to bids or to re bid based on the same criteria until acceptance or non response. It should be noted that step 8, 8A, 9 and 9A are only visible to the investor bidding or responding and to the corporation. Since the bid or re bid can involve various combinations from each investor, the corporation can choose those bids that best fits its needs. This may not relate to just money, as added value can be an important factor.

Step 10 requires both bidder and responder to agree on acceptance and at that point, the central computer calculates removal of shares from auction, thus ensuring auction integrity.

Step 11 shows how the auction winner is added to escrow by the corporation after the auction closes based on the closing date or shares still available, whichever comes first. The escrow process is very important, since during it, either the auction winner or the corporation can cancel after a period of due diligence. In this way there is a safeguard that a normal auction does not provide. All auction winners enter escrow at the same time, but escrow closing can occur early than preset.

Step 12 updates the corporate structure by having the central computer calculates new ownership of shares and money received by the corporation after escrow closes.

Step 13 continues the process as the new owner or owners can request an auction for selling their winning shares based on periodic reports from the corporation and their criteria for selling shares. It is found in practice that this solves a major problem that most investors have, as investors are now provided with an early exit strategy for either obtaining fast profit on their shares or quickly selling shares if they believe the corporation may have problems. Normally, investors have to wait until a corporation is acquired by another company or it becomes public to exit out, which can take years and in most cases never occurs.

Step 14 and 14A shows how investors input bids or re bids for shares, price per share, bid requirements, added value and response time.

Step 15 and 15A show how the investor that owns shares can respond to bids or to re bid based on the same criteria until acceptance or non response. These bid and response procedures are identical to the original auction.

Step 16 requires acceptance by both parties, as demonstrated in the original auction.

Step 17 show how the escrow phase is identical to the escrow phase in step 11.

Step 18 allows the corporation to add new owners and update the prior share holder.

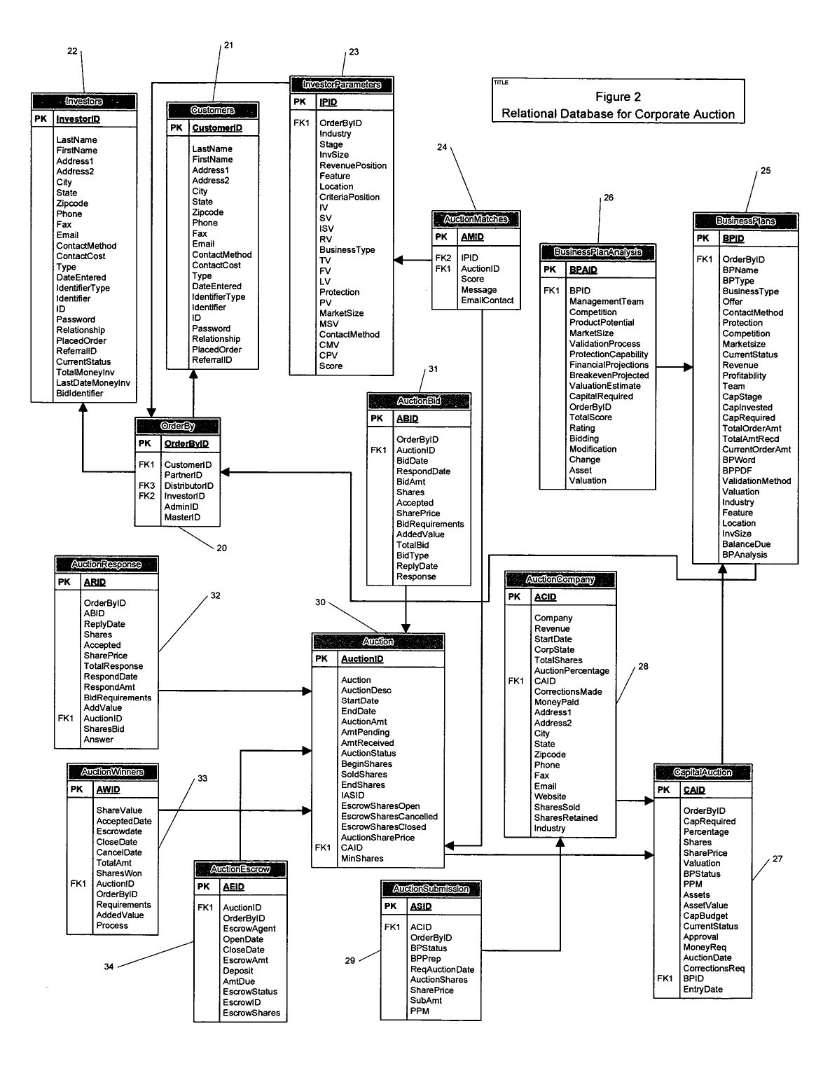

In accordance with the present invention, FIG. 2 demonstrates the relational database for the corporate auction by explaining the table structure and linkage between tables that is the basis of the program and the connections with FIG. 1. It is to be noted that a SQL type of relational database should be used that employs stored procedures so different records can be inserted, updated and deleted during the same process when required by the operator for faster performance. This in not mandatory but recommended.

FIG. 2, 20 is a link association that simplifies connection through the program.

FIG. 2, 21 is the customer table that relates to FIG. 1 step 1 above.

FIG. 2, 22 is the investor table that relates to FIG. 1 step 1A above.

FIG. 2, 23 is the investment criteria table that the investors can input with data shown in FIG. 1 step 1B.

FIG. 2, 24 is the criteria matching table that is link to an auction when it is set up in FIG. 1 step 7.

FIG. 2, 25 is the initial business plan table that the customer entered for analysis by the investors as shown FIG. 1 step 2.

FIG. 2, 26 is the analysis table criteria that investors enter where a total score and rating is calculated as shown in FIG. 1 step 3.

FIG. 2, 27 is the updated business plan data that is shown in FIG. 1 step 4.

FIG. 2, 28 is the table for the corporate structure shown in FIG. 1 step 6.

FIG. 2, 29 is the submission table that links FIG. 1 step 6 with FIG. 1 step 7.

FIG. 2, 30 is auction table that is entered by the moderator shown in FIG. 1 step 7.

FIG. 2, 31 is the auction bid table entered by the investor shown in FIG. 1 step 8 and FIG. 1 step 8A.

FIG. 2, 32 is the auction response table entered by the corporation shown in FIG. 1 step 9 and FIG. 1 step 9A.

FIG. 2, 33 is the auction winners entered by the corporation table shown in FIG. 1 step 10.

FIG. 2, 34 is the escrow table entered by the corporation shown in FIG. 1 step 11.

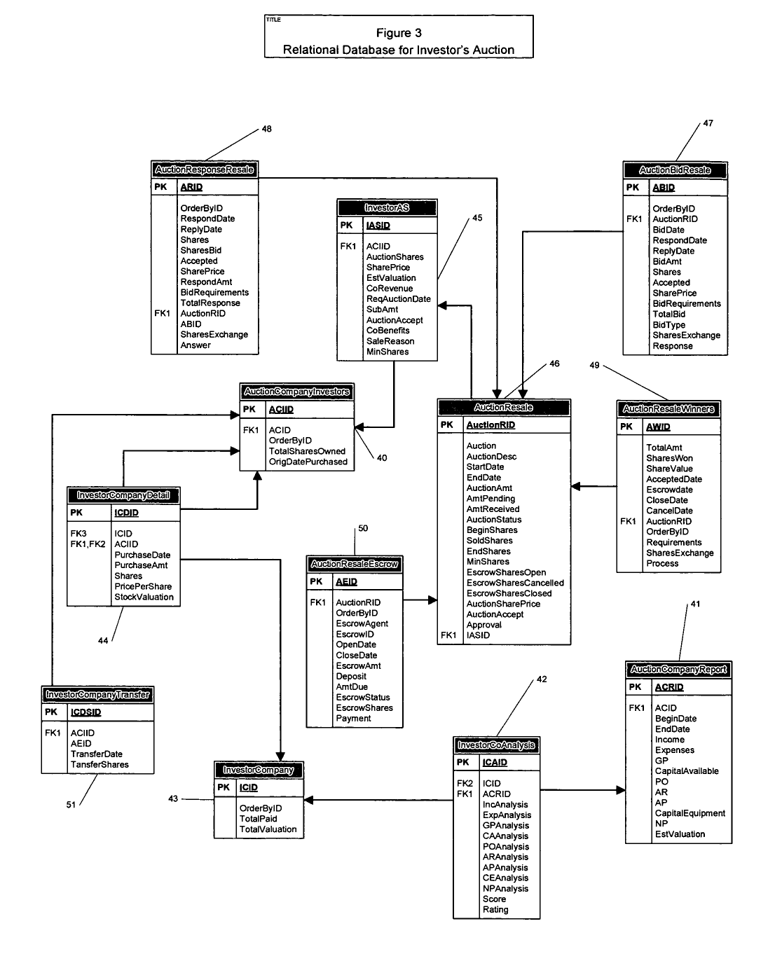

In accordance with the present invention, FIG. 3 demonstrates the relational database for the investor auction by explaining the table structure and linkage between tables that is the basis of the program and the connections with FIG. 1.

FIG. 3, 40 is the table for total shares owned by the investor

FIG. 3, 41 is the table for periodic report generated by the corporation.

FIG. 3, 42 is the investor's table that analyzes the report

FIG. 3, 43 is the investor's table that tracks the average valuation that provide the investor with a reason for selling or not selling the shares owned

FIG. 3, 44 is a table of shares acquired at different auctions for the same corporation that the investor may have participated in that is totaled in table 40

FIG. 3, 45 is the investor's sell criteria that triggers an investor's auction.

FIG. 3, 46 is the investor's auction requested by the investor but set up by the moderator as shown in FIG. 1 step 13.

FIG. 3, 47 is the auction bid or re bid by an other investor shown in FIG. 1 step 14 and FIG. 1 step 14A that wants to purchase these shares.

FIG. 3, 48 is the auction response to the bid or re bid by the investor owner shown in FIG. 1 step 15 and FIG. 1 step 15A.

FIG. 3, 49 is the auction winner's table for investor's shares shown in FIG. 1 step 16 that is entered by the corporation.

FIG. 3, 50 is the escrow table shown in FIG. 1 step 17 that is entered by the corporation.

FIG. 3, 51 is share transfer table that links to the corporate investors and that is also shown in FIG. 1 step 12 and FIG. 1 step 18.

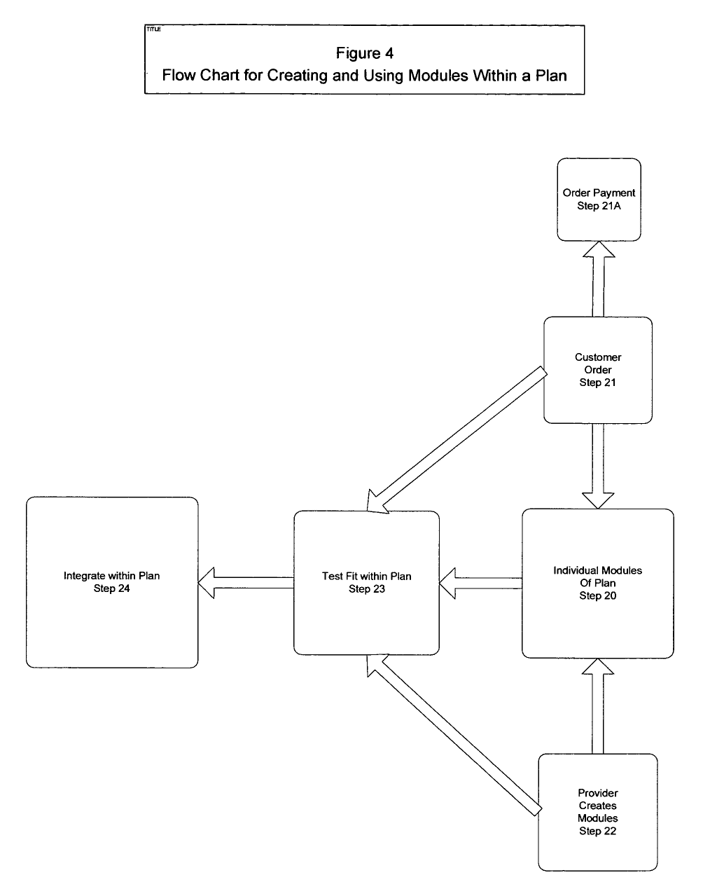

The present invention is also concerned with the capability of a corporation to write an effective business plan; therefore, FIG. 4 displays a method or process for creating and selling semi custom building block modules that can be used within a business plan for creating an effective sales tool to attract investors described in claim B1.

FIG. 4 step 20 provides a viewing of the various selections available and how they can be integrated into various plans.

FIG. 4 step 21 provide an on-line ordering system with entry forms where the customer inputs required data necessary to purchase modules.

FIG. 4 step 21A calculating a price for each module chosen that gives the customer the ability to purchase said modules through a credit card transaction in accordance with the terms of the purchase.

FIG. 4 step 22 provide a completed preliminary draft for the module.

FIG. 4 step 23 is an interactive phase where the module is integrated within the current plan to determine proper fit. Minor changes are made during this step to ensure a correct fit as the customer and a seller can work in real time if needed to complete the project.

FIG. 4 step 24 completes the integration with appropriate formatting to the plan for the correct output.

The apparatus according to claim B1, is also designed to accommodate marketing or other modules in a like manner that are comprised of various elements that can be used or operated independently. These modules can be used as either building blocks or fitted within already establish structures or plans, as cost effective solutions for a corporation. This independent claim is not necessarily limited to this invention, as it can be used in other areas.

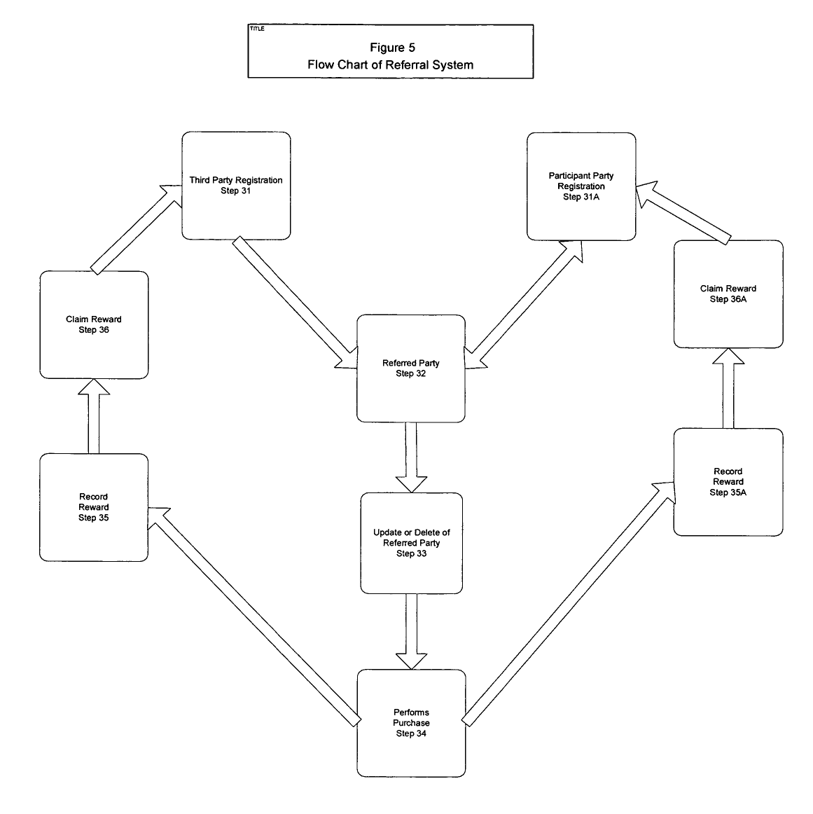

The present invention is also concerned with promoting the benefits of the invention to others; therefore, the apparatus according to claim Cl FIG. 5, demonstrates how new accredited investors interested in bidding and new customers interested in having their business plans funded through an on-line auction can be acquired through a referral reward system.

This is shown by how a referral from either a third party that pays a fee or a participant party is rewarded if a new referred participant registers and generate revenue through any program within the system comprising the steps as follows:

FIG. 5 step 31 shows where a third party can register if not already registered. A section in the registration portion of the program matches the participating party against a table of prior third parties and other parties, which prevents duplicate entry.

FIG. 5 step 31A shows where a participating party can register if not already registered by checking a referral check box, if the participating party was referred. A section in the registration portion of the program matches the participating party against a table of referred parties, as a field in the registration table establishes the link between the participating party and the referral party, if the particpating party was previous entered as a referred party. Particpating party is also matched against other particpating parties to prevent duplication.

FIG. 5 step 32 is a separate section where the third party or participant party can input data relating to a referred party that includes personalized message and best method of contact. The referred party is matched against all other tables that contain people by last name and phone number or last name and email address, wherein a match is rejected and a non match is accepted.

FIG. 5 step 33 is an update and delete section where the third party or participant party can modify or delete referred party, wherein if last name, phone number or email are change then a match is instituted as before for acceptance or rejection.

FIG. 5 step 34 shows where a purchase performed and where a calculated output notification by email to the third party or participant occurs.

FIG. 5 step 35 uses a separate program that calculates the value of the purchase or performance based on certain criteria and records that amount in a record linked to the third party. This reward is different then a participant reward.

FIG. 5 step 35A uses the same program as FIG. 5 step 35 that calculates the value of the purchase or performance based on certain criteria and records that amount in a record linked to the participant party. This reward is different then a third party reward, which is determine by the initial registration.

FIG. 5 step 36 is an accounting program where additional rewards can be entered and payment of rewards can be recorded to the third party.

FIG. 5 step 36A is the same accounting program described above where additional rewards can entered and payment of rewards can be recorded to the participant party.

Since acquiring these individuals can be costly and time consuming without any guarantee of success, the referral reward program can achieve better results without up front expense and can generate additional income from fees charged to paying third parties. This independent claim is not necessarily limited to this invention, as it can be used in other areas.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method or process for selling shares of stock by a private corporation at different arrangements to a plurality of accredited investors over the Internet comprising the steps of:
an on-line network of computers operating independently but linked to the central computer that comprise a method for raising capital by bidding on available shares based on different arrangements;
inputting registration to the central computer by a customer and a plurality of accredited investors for bidding on an on-line auction controlled by an opening and a closing date and available shares;
inputting a numerical score where investors can rate a business plan based on multiple categories and 1 to 10 scale for each category that when added together produces a total that converts to a criteria analysis;
inputting a business plan to the central computer by the customer wanting to raise capital for a corporation that can be modified for an auction after reviewing the criteria analysis by the investors;
inputting request for auction by the corporation that can be accepted or rejected by a moderator based on shares, price per share, valuation and criteria analysis by the investors;
outputting to the investor a notification of auction that matches the investor's criteria for bidding;
inputting bid or re bid to an open auction through the central computer by the investor based on personal interest or bidding criteria;
inputting the response to a bid or the response to a re bid from either the investor or the corporation on an open auction via the central computer until a mutual acceptance or the response date expires;
inputting all auction winners to escrow by the corporation when either the closing date is reached or all shares are sold, whichever comes first;
inputting an escrow period for the final auction winners and the corporation so they can perform due diligence for accepting or canceling the sale; and
inputting a new auction for an auction winner to sell the winning shares to other investors at any future time.

2. A method or process for selling shares of stock by private a corporation at a different arrangement to accredited investors over the Internet as claimed in claim 1 further comprising an auction method of selling a multiple quantity of shares at different preset criteria.

3. A method or process for selling shares of stock by private corporations at different arrangements to accredited investors over the Internet as claimed in claim 1 further comprising a method of selling a multiple quantity of shares at different preset criteria on a first come basis.

4. A method or process for selling shares of stock by private corporations at different arrangements to accredited investors over the Internet as claimed in claim 1 further comprising an auction method of selling a multiple quantity of shares at different criteria requested from a pre auction analysis by investors.

5. A method or process for selling shares of stock by private corporations at different arrangements to accredited investors over the Internet as claimed in claim 1 further comprising a method of selling a multiple quantity of shares at an average criteria requested from a separate analysis by investors on a first come basis.

6. A method or process for selling shares of stock by private corporations at different arrangements to accredited investors over the Internet as claimed in claim 1 further comprising a method for limiting the type of accredited investor allowed to bid on the auction from a preset criteria.

7. A method or process for selling shares of stock by a private corporation at different arrangements to a plurality of accredited investors over the Internet as claimed in claim 1 further comprising that business plan valuation criteria be determined by an average of the scores retrieved from an investor business plan analysis without input from a moderator.

8. A method or process for selling shares of stock by a private corporation at different arrangements to a plurality of accredited investors over the Internet as claimed in claim 1 further comprising that the selling price per share be based on shares for sale and valuation criteria determined by an average of the scores retrieved from the investor's business plan analysis by having the central computer execute the program without input from the corporation or a moderator.

9. A method or process for creating and selling semi custom building block modules with real time updating that can be used within a specific structure or plan for use by a customer to generate revenue for a business comprising the steps of:
an on-line computer where the customer can input data relating to the type and purpose of the structure or plan;
an entry forms related to the particular module with criteria for data entry for the specific structure or plan;
an interactive form and update display where the customer and a seller can work in real time if needed to complete the project;
a price list comprising various types of building block modules; and
calculating a price for each module chosen that gives the customer a right to purchase said modules through a credit card transaction in accordance with the terms of the purchase.

10. A method or process for creating and selling semi custom building block modules with real time updating that can be used within a specific structure or plan for use by a customer to generate revenue for a business as claimed in claim 9 further comprising that several building block modules can be linked to together to be fitted with a project or until a project is completed.

11. A method or process for obtaining participants by a referral from either a third party or a participant party wherein these parties can be rewarded on a separate basis if a new participant registers and generate revenue through any program within the system comprising the steps of:
an on-line computer where a third party can register if not already registered on a fee basis and a participant party can register if not already registered as a participant;
a separate section where the third party or participant party can input data relating to the referred party, personalized message and method of contact;
a system where the referred party is match against all other tables that contain people by last name and phone number or last name and email address, wherein a match is reject and a non match is accepted;
an update and delete section where the third party or participant party can modify or delete referred party, wherein if last name, phone number or email are change then a match is instituted as before for acceptance or rejection;
a check box on all registration sections of a participant party requesting if the registering party was referred;
a section in the registration portion of the program that matches the participant party against a table of referred parties;
a field in the registration table that links the new participant party to the third party or prior participant party;
a calculated output response to the third party or participant party occurs if the new participant party performs a service or purchases a product or service that results in revenue generated through any program within the system;
a separate program that calculates the value of the purchase or performance based on certain criteria and records that amount in a record linked to the third party or participant party; and
said program performs an accounting where additional rewards can entered and payment of rewards can be recorded on separate basis that depends on how they initially registered.
